(19) United States
(12) Patent Application Publication
(10) Pub. No.: US 2026/0135313 A1
(43) Pub. Date: May 14, 2026

(54) UNIT FOR TRANSMITTING FLUIDS AND ELECTRICAL SIGNALS WITH THERMAL DECOUPLING

(71) Applicant: MOOG GAT GMBH, Geisenheim (DE)

(72) Inventors: Dennis Hoff, Nieder-Hilbersheim (DE); Peter Stephan, Hünstetten/Kesselbach (DE); Robert Raum, Nürnberg (DE)

(21) Appl. No.: 19/118,848

(22) PCT Filed: Sep. 26, 2023
(86) PCT No.: PCT/EP2023/076598

§ 371 Date: Apr. 15, 2025

(30) Foreign Application Priority Data
Sep. 27, 2022 (DE) 10 2022 124 884.4

(51) Int. Cl. H01R 13/00; H01R 13/52

(52) U.S. Cl. CPC H01R 13/005; H01R 13/5219

(57) ABSTRACT

The present invention relates to a combined rotary feed-through having stationary and rotating contact parts for transferring fluids, data and electrical energy, comprising a housing, which has a fluid unit as a rotary feed-through for fluid connection in the connection-side region of the housing, said fluid unit having at least one feed port and at least one discharge port and a rotatable shaft, and the housing also having at least one communication unit as a rotary feed-through for transmitting electrical signals in an operation-side region of the housing, said communication unit having at least one electronic connection point. The combined rotary feed-through also comprises at least one supply unit for transmitting electrical energy as a rotary feed-through on the end face of the operation-side region of the housing, said supply unit having at least one electrical connection point. In the housing, at least one intermediate element is formed between the fluid unit and the communication unit, and at least one transition is formed between the operation-side region of the housing and the supply unit located outside the housing on the end face.

A fluid rotary feed-through, often also referred to as a classic rotary feed-through, acts as a rotating interface for a fluid line between stationary and rotating devices. The transmitted fluid can be a liquid or a gas with positive pressure or negative pressure.

Fluid rotary feed-throughs have the technical disadvantage that significant waste heat is generated during operation, where waste heat is thermal energy that is generated e.g. by friction between the stationary and rotating components. The thermal energy is transmitted to the fluid to be transmitted and also to the structure itself. In addition, leakage during operation of the fluid rotary feed-throughs, which must be discharged accordingly. In addition, the fluid also heats up when used in the machine connected to the rotary feed-through.

Another known type of rotary feed-through is an electrical rotary transmitter, also known as a slip ring transmitter, which acts as a rotating interface between stationary and rotating devices in order to make it possible to transmit power and/or data streams.

If it is an electrical rotary transmitter which mainly transmits and processes data streams, there are limits to the usability of the internal electronics with regard to the temperature, especially elevated temperatures, and the electromagnetic compatibility of these electrical rotary transmitters also influences undisturbed operation. In addition, it is important for the sensitive electronics to be kept in a dry environment. In particular, leakage (unintentionally escaping fluids from adjacent assemblies) should not be able to enter the electrical rotary transmitter if possible. Here, it is problematic that a closed housing of the electrical rotary transmitters leads to an increase in temperature inside and has a negative effect on the electronics. In addition, this electrical rotary transmitter heats up above the ambient temperature, and so the operating temperature of the rotary transmitter continues to rise.

A further electrical rotary transmitter can be designed primarily for the transmission of power streams and thus for “power supply”. In this case, wear due to the abrasion of the slip ring contacts is usually expected, and so slip ring transmitters of this type have a high degree of wear and do not last long. This results in the worn slip ring transmitters having to be replaced during operation by using a new electrical rotary transmitter.

These different rotary feed-throughs and rotary transmitters can be configured with each other to form a combined system. Accordingly, such a combined system can consist, for example, of a fluid rotary feed-through, an electrical rotary transmitter for transmitting data streams and an electrical rotary transmitter for “power supply”. Such combined systems are known in the prior art but are large and unwieldy.

Producing combined systems in a compact design without the different assemblies negatively affecting each other is a major technical challenge. Above all, a combined system consisting of the fluid rotary feed-through, the electrical rotary transmitter for data streams and a rotary transmitter that is intended exclusively for power supply has the major technical challenge that all the above-mentioned disadvantages of the individual rotary feed-throughs and rotary transmitters are also combined in one system. In particular, the sale of the two individual electrical rotary transmitters as one unit unnecessarily increases the costs if the entire unit actually has to be replaced due to wear rather than just replacing the one rotary transmitter for “power supply”.

The fluid rotary feed-through helps the electrical rotary transmitter to heat up for the purpose of transmitting data streams. During operation, the electronics of this rotary transmitter, together with a warm ambient temperature, continue to heat up, and so the maximum permissible operating temperature can be reached and even exceeded. This will result in failure of the rotary transmitter and thus an overall failure of the combined system. Since combined systems are often used in safety-critical applications, such as wind power plants, controlling the operating temperature of the electrical rotary transmitter for transmitting data streams is particularly important. Another challenge is also to prevent the leakage from the fluid rotary feed-through from entering the electrical rotary transmitter. In addition, due to the very low electromagnetic compatibility of the electrical rotary transmitter, this in turn is very sensitive to the electrical smog emitted by the electrical rotary transmitter for “power supply”. In addition, the electrical rotary transmitter must also be protected against the abrasion of the sliding contacts from the electrical rotary transmitter for “power supply”.

A person skilled in the art uses the two electrical rotary transmitters as one unit, since they are only available on the market in this form. The disadvantage is that the electrical rotary transmitter for “power supply” wears out faster than the electrical rotary transmitter for “data transmission”. However, since a person skilled in the art usually uses these two rotary transmitters only as one unit, it is not intended to replace them separately from each other and they must therefore be replaced as a complete unit. That makes such a unit expensive. This means that cost-effective use of the combined system according to this prior art is not possible.

Especially in wind power plants, it is particularly important to enable the smallest possible size of a combined system of rotary feed-throughs with rotary transmitters, to group low-wear components and to form them independently of the components with high wear, in order to make it possible to easily and inexpensively replace the relevant components.

Starting from the known prior art, it is an object of the present invention to provide a combined rotary feed-through having stationary and rotating system parts for conducting fluids, data and electrical energy, which at least partially overcomes the disadvantages present in the prior art.

In particular, it is an object to provide a combined rotary feed-through in a compact design, which allows the transfer of the waste heat between the individual rotary feed-throughs and rotary transmitters to be reduced and the electromagnetic sensitivity to be improved. In addition, the combined rotary feed-through of the present invention allows an electrical rotary feed-through for “power supply” to be formed as a kind of disposable slip ring which can be replaced independently of the rest of the system in the event of wear. This makes the combined rotary feed-through system easier to maintain, more durable and also more cost-effective than the known rotary feed-throughs from the prior art.

This object is achieved by the subjects of the independent patent claims. Advantageous embodiments of the invention are described in the dependent patent claims and the following description.

According to a first aspect, the invention relates to a combined rotary feed-through having the features of patent claim 1. The combined rotary feed-through according to the invention can be designed with stationary and rotating system parts for conducting fluids, data and electrical energy. In addition, the combined rotary feed-through according to the invention can be designed with a housing comprising a fluid unit and at least one communication unit. The combined rotary feed-through may also have at least one supply unit.

This arrangement has the advantage that the fluid unit and the at least one communication unit, together with the at least one supply unit, can be formed in a compact design in the form of the combined rotary feed-through according to the invention. Advantageously, the housing can be formed in one part, but a multi-part, in particular two-part, configuration of the housing is also possible.

The housing can advantageously protect the at least one communication unit, which is formed in the housing, from electrical and magnetic interference caused by the at least one supply unit.

The fluid unit may be designed as a rotary feed-through for the fluid connection in a port-side region of the housing having in each case at least one supply port and one discharge port of a rotatable shaft. Thus, the fluid unit is a fluid rotary feed-through.

Advantageously, the supply and discharge ports can be attached radially to the housing and/or can also be attached coaxially with respect to the rotational axis of the fluid unit. A coaxial alignment of the ports can be provided both on the end face in the port-side region of the fluid unit and on the cylindrical surface of the housing. Furthermore, it is advantageous if the supply and discharge ports are also designed as ports for supplying and discharging fluid which is required for the fluid unit.

The at least one communication unit may be designed as a rotary feed-through for transmitting electrical signals in an operation-side region of the housing having at least one electronic port.

This has the advantage that the combined rotary feed-through according to the invention is modular and is particularly easy to maintain. The at least one electronic port can be a port for transmitting electronic signals such as data. The first electronic port can be used to connect an Ethernet cable. This has the advantage that high transmission rates are possible.

For transmitting electrical energy, the at least one supply unit may be designed as a rotary feed-through on the end face of the operation-side region of the housing having at least one electrical port.

The electrical port has the advantage that it can be used to transmit currents and voltages and thus supply the communication unit, the fluid unit and also the stationary and rotating system parts with current and voltage.

The combined rotary feed-through according to the invention can be characterized in that, in the housing of the rotary feed-through according to the invention, at least one intermediate element can be formed between the fluid unit and the communication unit.

The arrangement of the intermediate element advantageously prevents leakage or waste heat of the fluid unit from reaching the communication unit, with the result that the communication unit is thermally decoupled from the fluid unit and thus the operating temperature does not increase significantly and the electronic components within the communication unit also do not come into contact with the leakage of the fluid unit.

In addition, at least one transition may be formed between the operation-side region of the housing and the supply unit arranged on the end face outside the housing.

In an advantageous manner, the transition can protect the at least one communication unit in the housing from electromagnetic loads from the at least one supply unit.

Furthermore, by arranging the supply unit outside the housing, the inventors have found out in an advantageous manner that the supply unit can be replaced in the event of wear independently of the fluid unit and communication unit installed in the housing. This leads to the fact that the durable and comparatively expensive components, such as the fluid unit and communication unit, remain in the combined rotary feed-through according to the invention and, in contrast, only the comparatively inexpensive wear component, the supply unit, has to be replaced. This enables a cost-effective combined rotary feed-through according to the invention which also has a long service life.

In a preferred embodiment, the communication unit may be arranged in a bearing manner on the shaft of the fluid unit in the operation-side region of the housing. The shaft can also be a split shaft, and so the communication unit is arranged in a bearing manner on the split shaft.

This has the advantage that a particularly compact design is possible, in which the communication unit can be connected to the fluid unit on the housing side via a screw connection and/or the screw connection can be connected to the communication unit on the shaft side. This ensures a reliable communication unit. A static overdetermination is avoided in the respective embodiment by a retaining element, advantageously a pin. A static overdetermination is avoided in the respective embodiment by a retaining element, advantageously a pin.

In a further embodiment, the housing may be formed in at least two parts in the region of the communication unit.

The inventors have advantageously found in tests that the communication unit is protected from leakage from the fluid unit and is also decoupled from the waste heat of the fluid unit by a two-part housing in the form of a unit with a compact design. Furthermore, the influence of the electrical and magnetic interference of the slip ring can also be kept to a minimum.

In another embodiment, the housing may have at least one plug connection element. This plug connection element can be connected to the contacts of the shaft via at least one cable. In addition, the plug connection element can be electrically connected to the contacts of the communication unit via at least one cable. Advantageously, the at least one plug connection element can respectively be formed on the housing, preferably on the end face of the port-side region and operation-side region of the housing. The plug connection element can be installed on the end face in the operation-side region of the housing at the level of the supply unit. This has the advantage that a supply unit can be connected to the communication unit immediately without having to specifically connect individual cables.

This arrangement has the advantage that the at least one supply unit can be particularly easily attached to the housing in which the fluid unit and communication unit are accommodated. Thus, a combined rotary feed-through that is very easy to maintain is possible, since the wear-prone supply unit can be replaced with a simple “plug and play” handle. In this case, the supply unit also has, at the corresponding location on its opposite end face, a plug connection element which represents the counterpart to the other plug connection element. This allows quick, uncomplicated replacement of the supply unit in the event of wear and therefore maintenance of the entire combined rotary feed-through.

In a preferred embodiment, at least one sealing element may be arranged in a region between the intermediate element and the communication unit in order to prevent leakage from the fluid unit into the communication unit.

The inventors have advantageously recognized in tests that, by virtue of the compact design and combination of the fluid unit and communication unit in a housing, a sealing element can contribute to the fact that leakage from the fluid unit cannot advance and/or penetrate into the communication unit or can do so at least only in very small amount. This protects the communication unit and allows a long service life of the communication unit to be achieved. This leads to the fact that the combined rotary feed-through according to the invention can operate for a long time without disruption. In addition, at least a portion of the at least one sealing element is formed from an elastomer material.

In a further embodiment, the intermediate element can at least partially provide thermal decoupling in one region.

This has the advantage that the waste heat of the fluid unit is not transferred to the communication unit and thus the communication unit can operate at an optimum lower operating temperature. This ensures the longevity of the communication unit, in particular the internal electronic components. Thus, the fluid unit and communication unit can be combined in a housing and only the supply unit remains as a wear part of the combined rotary feed-through according to the invention, but can be replaced at any time without great technical effort and above all cost-effectively.

In another embodiment, the intermediate element can discharge thermal energy using a passive element. The passive element can be a ventilation element for flowing through the intermediate element. One end of the at least one passive element may be fastened to the shaft. The passive element can represent, in a cross section as a spiral or in helical lines, a curve which runs around the shaft and moves away from the shaft as the center in the radial direction of the housing from that of the shaft. This has the advantage that a large amount of air or waste heat can still be conveyed from the intermediate element at a low speed of the shaft.

A passive element in the form of a scoop-shaped blade can provide a likewise high flow rate. In addition, two or more passive elements in the form of a scoop-shaped blade, in particular two scoop-shaped, overlapping blades, like a Savonius rotor, can be attached to the shaft.

This has the advantage that the intermediate element thermally decouples the fluid and communication unit. The inventors have advantageously found in tests that the thermal energy, in particular the waste heat of the fluid unit, can be conducted particularly effectively out of the housing away from the communication unit by means of a passive element. Thus, a compact design of the combined rotary feed-through according to the invention with different assemblies, such as the fluid unit and communication unit, is possible.

In a preferred embodiment, the intermediate element within the housing may form a spatial separation and a sealed transition between the fluid unit and the communication unit.

The spatial separation advantageously ensures that the fluid and communication unit are thermally decoupled. The inventors have advantageously found in tests that the communication unit can be isolated particularly effectively from the thermal energy, in particular the waste heat of the fluid unit, by a spatial separation. In addition, it is also advantageous that leakage from the fluid unit cannot advance into the communication unit due to the sealed transition.

A further advantage is that passive elements, by means of appropriately advantageous rotor blades, can be attached within the spatial separation of the intermediate element and the waste heat can thus be conveyed out of the housing away from the communication unit even more effectively. Thus, a compact design of the combined rotary feed-through according to the invention with different assemblies within a housing, such as the fluid unit and communication unit, is possible because thermal decoupling can be ensured.

In a preferred embodiment, the intermediate element may be formed with an air gap in the housing between the fluid unit and the communication unit.

By virtue of the air gap, the inventors have advantageously found in tests thermal decoupling of the fluid and communication unit, wherein the communication unit can be isolated particularly efficiently from the thermal energy, in particular the waste heat of the fluid unit, by the air gap.

A further advantage is that passive elements, such as ventilation elements, e.g. rotor blades, are additionally installed inside the air gap and the waste heat of the fluid unit can be conveyed out of the housing away from the communication unit even more effectively. Thus, a compact design of the combined rotary feed-through according to the invention with different assemblies within a housing, such as the fluid unit and communication unit, is possible.

Alternatively, the intermediate element can be filled with an insulating material from the housing to the passive element.

In a further embodiment, the intermediate element can discharge a leakage from the fluid unit to the outside via at least one opening radially formed in the housing.

This arrangement has the advantage that, despite the compact design of the combined rotary feed-through according to the invention and the accommodation of the fluid unit and communication unit in a housing, it is possible to prevent leakage that escapes from the fluid unit from entering the communication unit, since the leakage is guided out of the housing via the intermediate element. This increases the service life of the communication unit and ultimately the combined rotary feed-through overall since damage to the communication unit by the leakage can be prevented. In an advantageous manner, the at least one opening may be formed in the housing part which covers the intermediate element. This has the advantage that leakage can pass to the outside via the intermediate element and thus a flow in the direction of the communication unit or even entry of the leakage in the communication unit can be prevented. This effectively protects the communication unit from the leakage from the fluid unit and increases the service life of the communication unit. The opening may be a valve and/or membrane in order to allow leakage and warm air to pass to the outside from the housing.

In another embodiment, a ventilation system may be provided in the region of the intermediate element. For example, the ventilation system may be a cooling means, in which case ports for the cooling means of the customer may be provided on the housing. The ventilation system may also be an electrically driven fan impeller which may advantageously be formed in the intermediate element.

This has the advantage that the ventilation system thermally decouples the fluid and communication unit and thus enables a compact design, since the waste heat of the fluid unit is compensated for by the ventilation system. The inventors have advantageously found in tests that the thermal energy, in particular the waste heat of the fluid unit, can be conveyed particularly effectively out of the housing away from the communication unit by means of a ventilation system. Thus, a compact design of the combined rotary feed-through according to the invention with different assemblies, such as the fluid unit and communication unit, is possible.

In a preferred embodiment, the supply unit may continue to transmit electrical signals.

This has the advantage that a particularly compact rotary feed-through can be formed, since the electrical signals can reach the fluid unit and communication unit via the supply unit and can also simultaneously flow back via the supply unit and can be evaluated/processed and monitored there, for example by means of an evaluation unit, such as a computer connected to the combined rotary feed-through.

In a further embodiment, the supply unit may continue to optically transmit electrical signals.

This has the advantage that a particularly compact combined rotary feed-through can be formed, since the electrical signals can reach the fluid unit and communication unit via the supply unit and can also simultaneously flow back via the supply unit and can be evaluated/processed and monitored there, for example by means of an evaluation unit, such as a computer connected to the combined rotary feed-through.

In another embodiment, the housing may be formed from metal.

The inventors have advantageously found that a metal housing contributes to forming a Faraday cage. Thus, despite a compact design, a low interference sensitivity of the communication unit can be achieved, in particular with regard to electrical smog from the supply unit. This results in a faultless method of operation of the combined rotary feed-through.

In a preferred embodiment, the fluid unit and the at least one communication unit may be arranged beside one another on an axis of the shaft in the housing of the rotary feed-through. In this case, the shaft can form an inner shaft through the cables from the end face in the operation-side region to the end face in the port-side region, similar to a hollow spindle.

This arrangement advantageously leads overall to a compact and maintenance-friendly design of the combined rotary feed-through with the low-wear fluid unit and communication unit within a housing and the wear element, the supply unit, can be reached separately via the operation-side region in an easily accessible manner for replacement.

This has the advantage that a particularly effective thermal separation between the fluid unit and separation unit can be achieved, even though these are arranged within the same housing, since e.g. the waste heat can be discharged from the housing.

In another embodiment, a cooling device may be provided in the region of the intermediate element for cooling the at least one communication unit.

The inventors have found that it is furthermore advantageous to additionally also cool the communication unit in order to enhance the effect of the thermal separation of the fluid unit and separation unit. In particular, the communication unit is kept at an optimum intended operating temperature, which extends the service life of the communication unit. This allows the fluid unit and communication unit to be arranged in a housing without the risk of having to replace both units due to a low operating life of one unit. Advantageously, the cooling device in the intermediate element can be a hole which is formed parallel to the wall of the intermediate element, runs from an opening in the housing to just before the shaft 8, and thus directs cool ambient air into the intermediate element, which mixes with the waste heat and is then conveyed out of the intermediate element again from the housing. The cooling device thus contributes to the fact that the intermediate element can ensure high thermal decoupling between the fluid unit and communication unit. Alternatively, the hole with the opening in the housing may run parallel to the wall of the intermediate element, but instead of running inside the intermediate element, the cooling device may run in the communication unit. This also already lowers the interior temperature of the communication unit. Instead of a hole, a wall parallel to the intermediate element is also sufficient to form an annular channel equivalent to the hole in the sense of a pipe. In that case, the wall of the intermediate element would be the second wall.

In a preferred embodiment, the communication unit can transmit the electrical signals as data.

This is particularly advantageous since, due to the lack of space in a compact design of the combined rotary feed-through, it can be ensured that the method of operation of the combined rotary feed-through is still maintained in order to enable precise control, e.g. of an actuating element of a wind power plant.

In a further embodiment, the communication unit can contactlessly transmit the electrical signals.

The inventors have advantageously found in tests that contactless data transmission in a compact design of the combined rotary feed-through prevents contact transmission surfaces in the communication unit from wearing. Thus, a particularly long service life of the communication unit can be achieved and it becomes possible to hold the fluid unit and communication unit in one unit.

In another embodiment, the communication unit can capacitively transmit the electrical signals.

An advantage of a capacitive transmission of electrical signals is that, in a compact design of the combined rotary feed-through, the communication unit does not form any contact surfaces that can be subject to wear. Thus, a particularly long service life of the communication unit can be achieved and it becomes possible to hold the fluid unit and communication unit in one unit.

In another embodiment, a transmission of electrical signals from a first communication unit may be capacitive and a transmission of electrical signals from a second communication unit may be optical.

This arrangement has the advantage that two communication units are formed in a combined rotary feed-through according to the invention, thus making it possible to increase the redundancy and thus the failure safety of the combined rotary feed-through. This enables overall a compact design with the communication unit within a housing with the fluid unit.

In a preferred embodiment, the fluid unit can form at least one channel in which the fluid flows between the rotating body and fixed body.

This arrangement has the advantage that the fluid can reach the system and can be used there to regulate and control actuating elements or actuators.

In a preferred embodiment, a device for generating and providing an interior positive pressure in the housing may be provided.

The inventors have found that it is advantageous if it can be ensured in a compact design that the communication unit is not attacked by the leakage from the fluid unit. Providing an interior pressure advantageously achieves the situation in which leakage can be discharged from the housing and the communication unit is thus protected. This ensures the compact design and accommodation of the fluid unit and communication unit within a housing.

In a further aspect of the invention, the combined rotary feed-through can be used to control and regulate systems, in particular seismic measuring systems, wind turbines, centrifuges, filling systems, rotary indexing tables, rotating clamping systems and robots.

This has the advantage that, due to the compact design and long service life or very simple maintenance option, the combined rotary feed-through according to the invention can be used for many different applications.

Fluids within the meaning of the invention are liquid media such as oil, water, fat and emulsion, but in the present case fluids within the meaning of the invention should also be understood as meaning compressed air and gases.

Leakage is the unintended escape of fluid from the fluid unit in the direction of the communication unit.

According to the present invention, the port-side region of the housing is the region closer to the system parts, wherein the end face of the housing can be in contact with the system in the port-side region and can be connected to said system via a flange.

According to the present invention, the operation-side region of the housing is the region that is downstream of the port-side region when viewed from the system and is closer to the operator. Thus, the operation side is the shaft side of the combined rotary feed-through.

Rotary feed-throughs for transmitting electrical signals are either used to transmit signals, i.e., for example, for transmitting sensor signals, in order to capture and measure any state variables of a rotating machine part, and/or they consist of control signals used to control electrically operated units on the stationary and/or rotating machine part, or they are power lines that supply electrical energy used to operate electrical units and the like. The electrical energy is electrical current and voltage. Depending on the application, different voltage ranges can be transmitted as electrical energy; known voltage ranges are in the range of −400 V to 400 V for three-phase AC voltage (colloquially three-phase current or power current), preferably in the range of −230 V to 230 V, further preferably in the range of −24 V to 24 V and in particular in the range of −12 V to 12 V.

Sensor signals and control signals can also be transmitted as data and typically have a voltage range of between −6 V and 6 V. Different known communication protocols from industry can be used to transmit the data. The RS-485 standard for duplex communication is mentioned here, for example.

Within the scope of the present invention, the term “electrical signals” is intended to encompass all these types of electrical currents or voltages.

Passive elements for discharging thermal energy within the meaning of the invention are, for example, elements, such as rotor blades, which are fastened to already rotating components, such as the shaft of a rotary feed-through. As a result, they contribute to conveying the thermal energy, especially the waste heat of the fluid unit, out of the housing. The passive elements in the form of rotor blades can assume any shapes, preferably bent and matched to the intermediate element. In contrast, a ventilation system in the region of the intermediate element can be referred to as an active element. The ventilation system can be, for example, a cooling means, in which case ports for the cooling means are provided on the housing, to which customers can connect cooling units, or can be an electrically driven fan impeller which can preferably be formed in the intermediate element.

The above configurations and developments can be arbitrarily combined with each other, if appropriate. Further possible configurations, developments and implementations of the invention also include not explicitly mentioned combinations of features of the invention described above or below with respect to the exemplary embodiments. In particular, a person skilled in the art will also add individual aspects as improvements or additions to the respective basic form of the present invention.

The present invention is explained in more detail below using the exemplary embodiments indicated in the schematic figures of the drawings, in which:

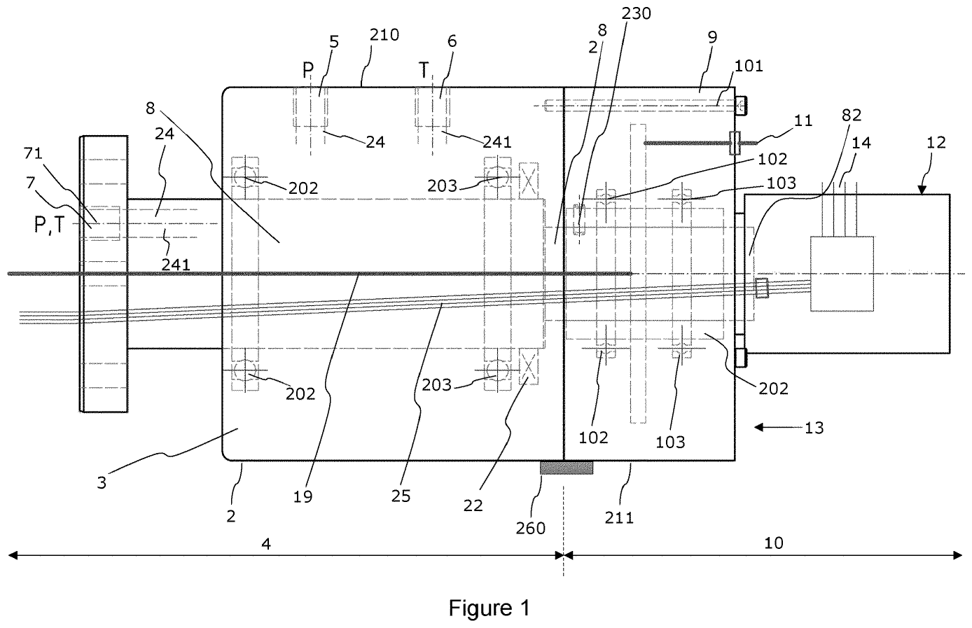

FIG. 1 shows a combined rotary feed-through according to the invention

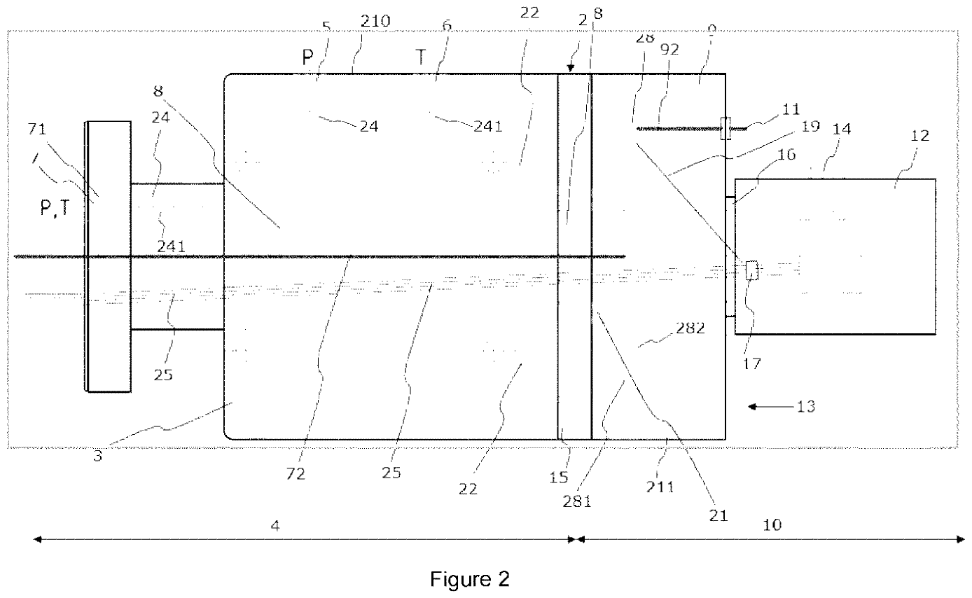

FIG. 2 schematically shows a further combined rotary feed-through according to the invention

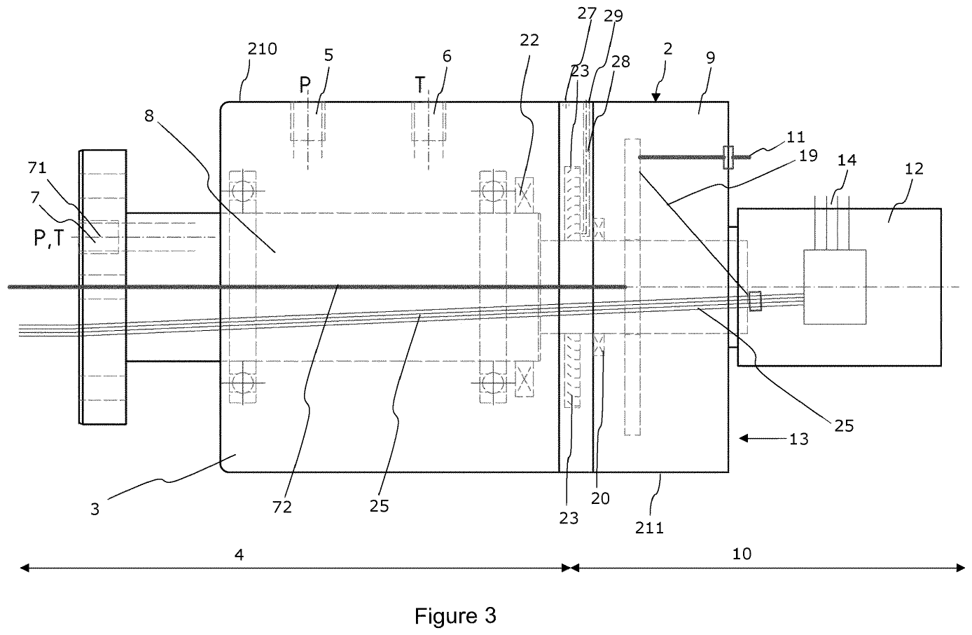

FIG. 3 schematically shows an alternative combined rotary feed-through according to the invention

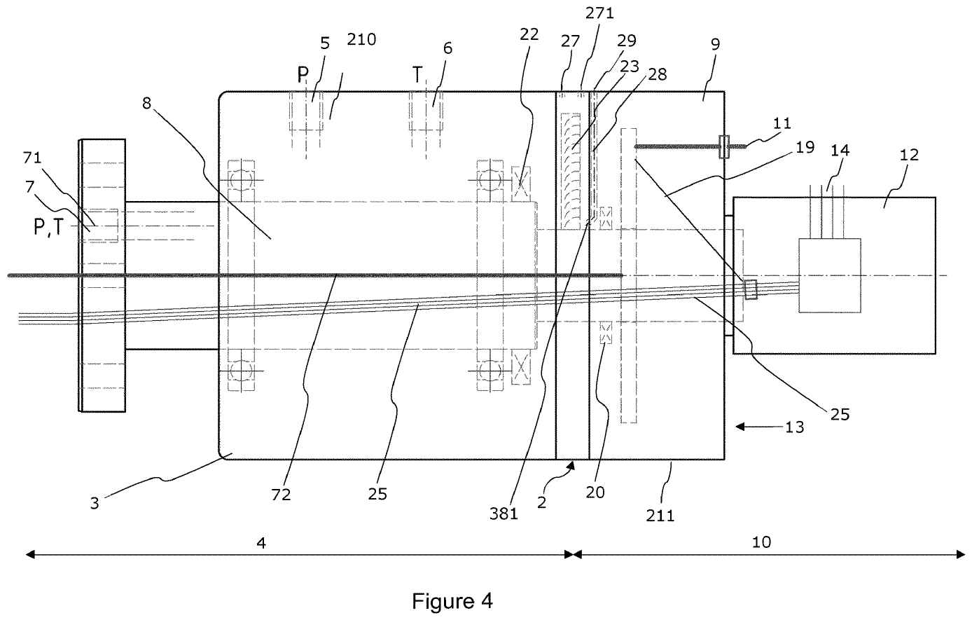

FIG. 4 schematically shows a further combined rotary feed-through according to the invention

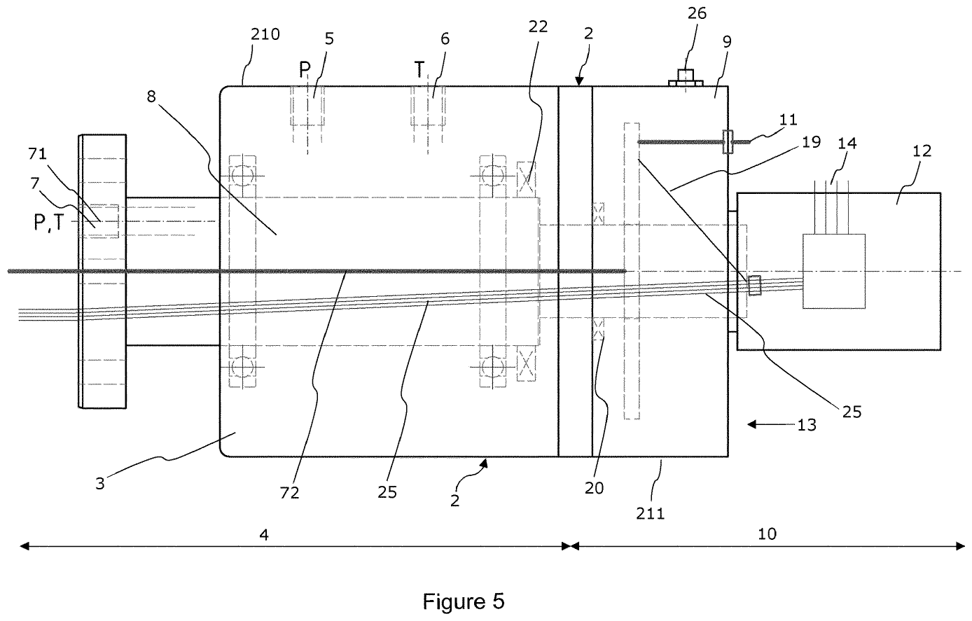

FIG. 5 schematically shows an alternative combined rotary feed-through according to the invention

The accompanying drawings are intended to provide a further understanding of the embodiments of the invention. They illustrate embodiments and serve, in conjunction with the description, to explain principles and concepts of the invention. Other embodiments and many of the advantages mentioned emerge with regard to the drawings. The elements of the drawings are not necessarily shown to scale with respect to each other.

In the figures of the drawing, identical, functionally identical and identically acting elements, features and components, unless otherwise specified, are each provided with the same reference signs. In particular, FIGS. 1 to 5 build on each other, which is why identically acting elements, features and components, unless otherwise specified, are not completely provided with reference signs for the sake of clarity. However, a person skilled in the art recognizes that they are identically acting elements, features and components and may add the corresponding reference signs from the preceding figure.

Finally, it should be noted that the description of the invention and the exemplary embodiments should not be understood in principle as being restrictive with respect to a specific physical implementation of the invention. All the features explained and shown in connection with individual embodiments of the invention may be provided in a different combination in the subject matter according to the invention in order to achieve their advantageous effects at the same time.

The scope of protection of the present invention is given by the claims and is not limited by the features explained in the description and/or shown in the figures.

FIG. 1 shows by way of example a combined rotary feed-through 1 of the invention. This combined rotary feed-through consists of a housing 2 with a fluid unit 3, a communication unit 9 and an intermediate element 15, which is arranged for thermal insulation between the fluid unit 3 and communication unit 9. The intermediate element 15 in FIG. 1 is accommodated in the housing 2 and forms a narrow layer of insulating material, preferably heat-resistant plastic or elastomer with a low thermal conductivity. The communication unit 9 is a rotary feed-through for transmitting electrical signals and the supply unit 12 is a rotary feed-through for transmitting electrical energy.

In the housing 2, the fluid unit 3, which is a rotary feed-through for fluids, is located in a port-side region 4 and the communication unit 9 is located in the operation-side region 10. The communication unit 9 is connected to an end face of the fluid rotary feed-through 3 in the operation-side region 10 by means of a fastening means 1011, preferably the screw 101, via the intermediate element 15. The communication unit 9 and the fluid unit 3 are arranged so as to be mounted around the shaft 8 of the fluid unit 3 in FIG. 1 by means of bearing elements 102, 103 and bearing elements 202, 203.

The communication unit 9 and the housing 2 with the housing part 211 and the associated parts are mounted on the shaft 220 via the bearing elements 102, 103. The shaft 220 is supported on the shaft 8 via a retaining element 230, preferably a pin.

An alternative embodiment, not shown in FIG. 1, is to connect the shaft 220 on the shaft 8 to each other. For this purpose, for example, the fastening means 101, preferably the screw, instead of connecting the housing 2 as shown in FIG. 1, is used to connect the shaft 220 to the shaft 8. In this alternative, the housing part 211 of the communication unit 9 is supported on the housing part 210 of the fluid unit 3 by means of at least one connection element 260 in such a way that no static overdetermination occurs. The connection element 260 may be formed within the housing as a pin or may be attached to the outside of the housing 2 and, from the housing part 210 of the fluid unit 3, may bridge the intermediate element 15 and engage in the housing part 211 of the communication unit 9, preferably in the form of a retaining clip.

The fluid unit 3 in FIG. 1 respectively has a fluid port P for supplying the fluid and a fluid port T for the return, which can be formed both coaxially with respect to the shaft 8 in the direction of the machine part and radially on the housing part 210 of the fluid unit 3. FIG. 1 indicates the channels 24, 241 formed in the fluid unit 3 between the coaxial fluid ports 7, 71 and the radial fluid ports 5, 6. Further, at least one circumferential sealing element 22 of the fluid unit 3 is shown, in order to keep an escape of fluid in the direction of the intermediate element 15 and communication unit 9 as low as possible.

Details of the transfer of fluid via the channels 24, 241 or holes only indicated in FIG. 1 and the bearing and sealing of the shaft 8 in the fluid unit 3 are known from the prior art and are therefore not explained any further here.

The combined rotary feed-through according to the invention in FIG. 1 also shows that the fluid unit 3 in the housing part 210 of the housing 2 and the communication unit 9 in the housing part 211 of the housing 211 and the intermediate element 15 are included in the housing 2 and thus form a unit. Separate from this, but part of the combined rotary feed-through 1 according to the invention, is the supply unit 12 which is attached to the side of the housing 2. Since the supply unit 12 is formed with high wear irrespective of the resistant fluid unit 12 and especially the communication unit 9, the supply unit 12 can be replaced quickly and cost-effectively independently of the rest of the combined rotary feed-through 1.

FIG. 2 shows by way of example a combined rotary feed-through of the invention which is similar to the structure from FIG. 1, but with the difference that the intermediate element 15 is wider. The intermediate element 15 is optionally filled with an insulating material, as in FIG. 1. The wider design increases the effect of thermal insulation between the fluid unit 3 and the communication unit 9. Instead of the above-mentioned insulating material in the intermediate element 15, air can also be used as an insulating material. In this case, the intermediate element 15 contains an air gap.

The fluid unit 3, the communication unit 9 and the intermediate element 15 are still arranged in a housing 2. The intermediate element 15 forms a spatial separation and a sealed transition between the fluid unit 3 and the communication unit 9. FIG. 2 also shows a circumferential sealing element 21 on the right-hand edge of the intermediate element 15 on the shaft 8. This reduces and/or minimizes the amount of leakage that could possibly advance from the fluid unit 3 via the separating element 15 into the communication unit 9.

If air is used as an insulating material in the intermediate element 15, at least one opening, such as the openings 27, 271 from FIGS. 3 and 4, is necessary. These are not shown in FIG. 2, but must also be radially formed in the housing in the region of the intermediate element 15. Via the intermediate element 15 and the at least one opening, corresponding to the opening 27, 271, the possibly occurring heated leakage from the fluid unit 3, together with the waste heat (hot air), escapes to the outside from the housing 2.

FIG. 2 also shows a component which is formed separately therefrom and is the supply unit 12 from FIG. 1. The supply unit 12 transmits electrical energy, such as current and voltage of different magnitudes and voltage levels, from the operation-side region 10 to system parts in the port-side region 4, to which the combined rotary feed-through of the invention is connected. In this case, the current/voltage is supplied via the electrical port 14 by means of an electrical slip ring transmitter located in the supply unit 12 and a further port which is advantageously formed as a plug connection element 17 between the communication unit 9 and the supply unit 12. The cables 25 shown in FIG. 2 are electrically connected to the plug connection 17 and transmit the necessary current and voltage through the shaft 8 to the system parts in the port-side region 4.

FIG. 2 also shows how the supply unit 12 supplies the communication unit with current and voltage via the electrical port 14, the plug connection 17 and at least the one cable 19. In particular, the cable 19 electrically connects a second side 282 of the transmission unit 28 to the plug connection 17. An electronic port 11 which is located on the housing 2 is also shown. In FIG. 2, the electronic port 11 is formed in the operation-side region 10 on the end face 13 of the communication unit 9 and is preferably designed as an Ethernet port which is suitable for transmitting at least 5 gigabits per second. A cable 72, preferably an Ethernet cable, runs inside the shaft 8 from the port-side region to the communication unit 9 and makes contact there with a first side 281 of a transmission unit 28. The transmission unit 28 capacitively or optically transmits the electrical signals and/or data from the first side 281 to the second side 282. An intermediate cable 92 electrically connects the second side 283 to the electronic port 11. In this way, electrical signals are transmitted from system parts to evaluation computing units, such as computers, in the operation-side region 10 (not shown in FIG. 2). In addition, the cables 25 also run in the internally hollow shaft 8.

In a further example of the invention, not shown in FIG. 2, the cables 25 may run in a separate channel formed in the fluid unit 3, but not in the interior of the shaft 8. Also not shown in FIG. 2, a first and a second communication unit can be formed in succession in the housing 2. In this case, both communication units and their corresponding transmission units accordingly transmit an electrical signal capacitively or optically. This creates redundancy and makes the combined rotary feed-through even more durable and fail-safe.

FIGS. 3 and 4 build on FIG. 2 and show further examples of the combined rotary feed-through of the invention. In this case, a passive element 23 is formed in the intermediate element 15. The separating element may contain an air gap. Alternatively, the intermediate element 15 may consist of the known solid insulating materials, as in FIG. 2. In this case, a corresponding recess and connection holes from the passive element 23 to the opening 27 in the material of the intermediate element 15 would be provided for the passive element 23 in order to allow free air circulation. The passive element 23 is fastened on the shaft 8 and extends radially. The passive element 23 rotates with the shaft 8. The passive element 23 is schematically shown in FIGS. 3 and 4 and is at least schematically a rotor blade or a ventilation element. The exact shape and length vary according to the application; due to the low number of revolutions of the shaft, a passive element that can convey as large a quantity of air as possible due to the surface area of the passive element used is preferred.

In FIG. 3, a cooling device 48 in the intermediate element 15 parallel to the wall of the intermediate element 15 is a pipe which is formed by a hole 38 and runs from an opening 29 in the housing 2 to just before the shaft 8 and thus conducts cool ambient air into the intermediate element 15, in which the rotating passive element draws in the air. Through rotation in the intermediate element 15, the passive element 23 conveys the air out of the housing 2 again via the opening 29 in the housing 2. FIG. 3 shows only one opening 29 by way of example, but a plurality of the openings 29 may be formed circumferentially on the lateral surface of the housing 2. Drawing in cool air and conveying it out of the housing 2 again produces thermal circulation which cools the intermediate element and thus increases the thermal decoupling of the communication unit 9 from the fluid unit 3. The cooling device 48 and the rotating passive element 23 thus contribute to the fact that the intermediate element 15 can ensure adequate thermal decoupling between the fluid unit 3 and communication unit 9.

Alternatively, in FIG. 4, the hole 38 with the opening 29 in the housing 2 may run parallel to the wall of the intermediate element 15, but instead of running inside the intermediate element 15, the cooling device 48 may run in the communication unit 9. This also lowers the interior temperature of the communication unit 9 and prevents the maximum permissible operating temperature from being exceeded. As FIG. 4 shows, a lateral through-hole 381 from the communication unit to the intermediate element 15 is necessary in this case. The circumferential sealing element 21 is accordingly arranged with an offset in order to give the necessary space to the through-hole 381.

Instead of a hole 38 as a cooling device 48 in FIG. 3 and FIG. 4, a wall parallel to the separating element 15 is also sufficient to provide an annular channel equivalent to the hole 38. In that case, the wall of the separating element 15 would be the second wall.

FIG. 5 builds on FIGS. 2, 3 and 4 and shows a further example of the combined rotary feed-through of the invention. In this case, a further port 26 is shown on the housing 2 in the region of the communication unit 9. Many elements, features and components of FIGS. 1 to 4 have been omitted in FIG. 5, but these can be easily combined with the port 26 in order to keep the operating temperature of the communication unit 9 as low as possible. In order to maintain clarity, the passive element 23 such as the rotor was not illustrated in FIG. 5. The port 26 is used to generate a cool air flow and a positive pressure in the interior of the communication unit 9 by means of air from outside the housing 2. This will lower the temperature in the communication unit 9. The port 26 for generating a positive pressure can be combined with all examples of the combined rotary feed-through.

Finally, it should be noted that the description of the invention and the exemplary embodiments should not be understood in principle as being restrictive with respect to a specific physical implementation of the invention. All the features explained and shown in connection with individual embodiments of the invention may be provided in a different combination in the subject matter according to the invention in order to achieve their advantageous effects at the same time.

The scope of protection of the present invention is given by the claims and is not limited by the features explained in the description and/or shown in the figures.

### LIST OF REFERENCE SIGNS

1 Combined rotary feed-through
2 A housing
3 A fluid unit
4 Port-side region
5, 7 Supply port
6, 71 Discharge port
8 Rotatable shaft
9 Communication unit
10 Operation-side region
11 Electronic port of the communication unit 9
12 A supply unit
13 End face of the operation-side region 10 of the housing 2
14 Electrical port of the supply unit 12
15 Intermediate element
16 A transition
17 Plug connection element
19 At least one cable
21 Circumferential sealing element on the communication unit
22 Circumferential sealing element in the fluid unit
24, 241 At least one channel
25 At least one cable
23 At least one passive element
27 Opening
28 Transmission unit
281 First side of the transmission unit
282 Second side of the transmission unit
48 Cooling device
72 Cable
92 Intermediate cable
101 Fastening means, screw
102, 103 Bearing of the communication unit
202, 203 Bearing of the fluid unit
210 Housing part of the communication unit
211 Housing part of the fluid unit
220 Shaft of the communication unit
230 Retaining element, pin
260 Connection element
381 Through-hole

1. A combined rotary feed-through having stationary and rotating system parts for conducting fluids, data and electrical energy, having:
a housing comprising:
a fluid unit as a rotary feed-through for the fluid connection in the port-side region of the housing having in each case at least one supply port and one discharge port and a rotatable shaft;
at least one communication unit as a rotary feed-through for transmitting electrical signals in an operation-side region of the housing having at least one electronic port; and
at least one supply unit for transmitting electrical energy as a rotary feed-through on the end face (13) of the operation-side region (10) of the housing (2) having at least one electrical port (14);
wherein, in the housing, at least one intermediate element is formed between the fluid unit and the communication unit and at least one transition is formed between the operation-side region of the housing and the supply unit arranged on the end face outside the housing.

2. The combined rotary feed-through as recited in claim 1, wherein the communication unit is arranged in a bearing manner on the shaft of the fluid unit in the operation-side region (10) of the housing (2).

3. The combined rotary feed-through as recited in claim 1, wherein the housing is formed in at least two parts in the region of the communication unit.

4. The combined rotary feed-through as recited in claim 1, wherein the housing has at least one plug connection element which is electrically connected to contacts of the shaft via at least one cable and is electrically connected to contacts of the communication unit via at least one cable.

5. The combined rotary feed-through as recited in claim 1, wherein at least one sealing element is arranged in a region between the intermediate element and the communication unit in order to prevent leakage into the communication unit.

6. The combined rotary feed-through as recited in claim 1, wherein the intermediate element at least partially provides thermal decoupling.

7. The combined rotary feed-through as claimed in claim 6, wherein the intermediate element discharges thermal energy using at least one passive element, in particular of at least one rotor.

8. The combined rotary feed-through as recited in claim 1, wherein the intermediate element within the housing forms a spatial separation and a sealed transition between the fluid unit and the communication unit.

9. The combined rotary feed-through as recited in claim 1, wherein the intermediate element is formed with an air gap in the housing between the fluid unit and the communication unit.

10. The combined rotary feed-through as recited in claim 1, wherein the intermediate element discharges a leakage from the fluid unit to the outside via at least one opening radially formed in the housing.

11. The combined rotary feed-through as recited in claim 1, wherein a ventilation system is provided in the region of the intermediate element.

12. The combined rotary feed-through as recited in claim 1, wherein the supply unit continues to transmit electrical signals.

13. The combined rotary feed-through as recited in claim 1, wherein the supply unit continues to optically transmit electrical signals.

14. (canceled)

15. The combined rotary feed-through as recited in claim 1, wherein the fluid unit and the at least one communication unit are arranged beside one another on an axis of the shaft in the housing of the rotary feed-through.

16. The combined rotary feed-through as recited in claim 1, comprising a cooling device in the region of the intermediate element for cooling the at least one communication unit.

17. The combined rotary feed-through as recited in claim 1, wherein the communication unit transmits the electrical signals as data, contactlessly transmits the electric signals, and/or capacitively transmits the electrical signals.

18. (canceled)

19. (canceled)

20. The combined rotary feed-through as recited in claim 1, wherein a transmission of electrical signals from a first communication unit is capacitive and a transmission of electrical signals from a second communication unit is optical.

21. The combined rotary feed-through as recited in claim 1, wherein the fluid unit forms at least one channel in which the fluid flows between the at least one radial fluid port and the at least one axial fluid port.

22. The combined rotary feed-through as recited in claim 1, further comprising a device for generating and providing an interior positive pressure in the housing.

23. The use of the combined rotary feed-through as recited in claim 1 to control and regulate systems, in particular seismic measuring systems, wind turbines, centrifuges, filling systems, rotary indexing tables, rotating clamping systems and robots.
